(19) United States
(12) Patent Application Publication
(10) Pub. No.: US 2026/0141629 A1
(43) Pub. Date: May 21, 2026

(54) METHOD FOR GENERATING SOFT SHADOW, ELECTRONIC DEVICE AND STORAGE MEDIUM

(71) Applicant: NETEASE (HANGZHOU) NETWORK CO., LTD., Hangzhou, Zhejiang (CN)

(72) Inventor: Yandong MEI, Hangzhou, Zhejiang (CN)

(73) Assignee: NETEASE (HANGZHOU) NETWORK CO., LTD., Hangzhou, Zhejiang (CN)

(21) Appl. No.: 19/118,798

(22) PCT Filed: Mar. 17, 2023
(86) PCT No.: PCT/CN2023/082265

§ 371 Date: Apr. 7, 2025

(30) Foreign Application Priority Data
Oct. 8, 2022 (CN) 202211229765.3

(51) Int. Cl. G06T 15/60; A63F 13/52; G06T 15/50

(52) U.S. Cl. CPC G06T 15/60; A63F 13/52; G06T 15/506; G06T 2210/12; G06T 2210/21

(57) ABSTRACT

A method for generating a soft shadow, includes: in response to a loading instruction for a game, obtaining blocking information of a virtual scene and light source information based on a light source in the virtual scene; in a running process of the game, determining a target rendering pixel point in the virtual scene according to the light source information, where the target rendering pixel point is to be subjected to illumination rendering: determining a directed distance of the target rendering pixel point according to the blocking information and the light source information; and determining illumination intensity ratio of the light source to the target rendering pixel point based on the directed distance of the target rendering pixel point, where the illumination intensity ratio indicates an influence degree of the light source on shadow generation for the target rendering pixel point.

### CROSS REFERENCE TO RELATED APPLICATIONS

The present application is a National Stage Application of International Application No. PCT/CN2023/082265 filed on Mar. 17, 2023 which is based upon and claims the priority of Chinese Patent Application No. 202211229765.3 entitled “Method for generating a soft shadow, Apparatus, Device, and Storage Medium,” filed on Oct. 8, 2022, the entire contents of both of which are incorporated herein by reference in their entireties for all purposes.

### TECHNICAL FIELD

The present disclosure relates to the field of rendering technology, and in particular, to a method for generating a soft shadow, an apparatus for generating a soft shadow, a corresponding electronic device, and a corresponding computer storage medium.

### BACKGROUND

The light source in the virtual scene illuminates the surrounding object in a case of no blocking, and it is needed to generate a shadow for the light source in a case that the light source is blocked. In order to improve the authenticity of the shadow, a soft shadow with a gradual transition is usually used for the generated shadow.

In the related art of shadow generation, mostly, calculation of the illumination region is performed in a Central Processing Unit (CPU), and the calculated illumination region is separately placed in a texture of Render Texture, so that the illumination region is involved in subsequent illumination calculation based on the texture, to generate the shadow required in the virtual scene. However, for the manner of shadow generation by the CPU, when a relative change occurs between each frame of light source and the blocking position, the illumination region stored in the texture needs to be recalculated, which is not easy to support the soft shadow.

### SUMMARY

According to an aspect of the present disclosure, there is disclosed a method for generating a soft shadow, and the method includes:
in response to a loading instruction for a game, obtaining blocking information of a virtual scene and light source information based on a light source in the virtual scene;
in a running process of the game, determining a target rendering pixel point in the virtual scene according to the light source information, where the target rendering pixel point is to be subjected to illumination rendering;
determining a directed distance of the target rendering pixel point according to the blocking information and the light source information; and
determining illumination intensity ratio of the light source to the target rendering pixel point based on the directed distance of the target rendering pixel point, wherein the illumination intensity ratio indicates an influence degree of the light source on shadow generation for the target rendering pixel point.

According to an aspect of the present disclosure, there is further disclosed an electronic device, including a processor, a memory, and a computer program stored in the memory and capable of running on the processor; and when the computer program is executed by the processor, any one of the method for generating a soft shadow is implemented.

According to an aspect of the present disclosure, there is further disclosed a computer-readable storage medium, where the computer-readable storage medium stores a computer program; and when the computer program is executed by the processor, any one of the method for generating a soft shadow is implemented.

### BRIEF DESCRIPTION OF THE DRAWINGS

FIG. 1 is a flowchart of steps of a method for generating a soft shadow according to some embodiments of the present disclosure;

FIG. 2 is a schematic diagram of defining light source information provided according to some embodiments of the present disclosure;

FIG. 3 is a flowchart of steps of a method for generating a soft shadow according to some embodiments of the present disclosure;

FIG. 4 is a schematic diagram of generating illumination intensity ratio information provided according to some embodiments of the present disclosure;

FIG. 5 is a schematic diagram of an application scenario of generating a soft shadow provided according to some embodiments of the present disclosure;

FIG. 6 is a schematic diagram of a process of generating a soft shadow provided according to some embodiments of the present disclosure;

FIG. 7 is a structural block diagram of an apparatus for generating a soft shadow according to some embodiments of the present disclosure.

### DETAILED DESCRIPTION

In order to make the above-mentioned objectives, features and advantages of the present disclosure more obvious and understandable, the present disclosure will be further described in detail below with reference to the accompanying drawings and specific embodiments.

In order to facilitate those skilled in the art to understand the present disclosure, the terms or phrases involved in the following embodiments of the present disclosure are explained below.

SDF: Signed Distance Field (Function). SDF is used to define a distance, recorded by each pixel (voxel), between the pixel and a nearest object from the pixel. If the pixel is inside the object, the distance is negative. If the pixel is just on the boundary of the object, the distance is 0.

AABB: Axis-aligned bounding boxes. AABB is referred to as an axis-aligned bounding box. It means that, in order to simplify the calculation of collision detection between objects in a game, a regular geometric profile is usually created for an object to surround the object.

In the related art of shadow generation, mostly, calculation of the illumination region is performed in the CPU, and the calculated illumination region is separately placed in a texture Render Texture, so that the illumination region is involved in subsequent illumination calculation based on the texture, to generate the shadow required in the game scene.

However, this manner of generating a shadow is performed in the CPU. Since the CPU is also responsible for processing the calculation of the illumination region while processing other logic, the processing speed of the CPU is slow. Moreover, the correlation between data and calculation of the illumination region is significant; when the blocking is complex, the calculation amount of the CPU will be further increased, and the probability of error will become higher due to the complexity of the algorithm; and when a relative change occurs between each frame of light source and the blocking position, the illumination region stored in the texture needs to be recalculated, which is not easy to support the soft shadow.

One of the core concepts of the embodiments of the present disclosure is to propose a solution implemented based on a Graphic Processing Unit (GPU), which is fast, stable, and supports soft shadow. Mainly in the solution, calculation of the illumination region of the light source may be performed based on the obtained blocking information and the light source information during rendering, and since the GPU needs to perform less logic while performing the calculation of the illumination region, the calculation speed may be improved by performing the calculation operation of the illumination region based on the GPU. Moreover, the directed distance of the target rendering pixel point may be determined based on the blocking information and the light source information, and then the illumination intensity ratio information of the light source to the target rendering pixel point may be determined; and in this manner, due to the simple algorithm property for the directed distance, various complex situations do not need to be considered, and it is convenient for dynamic-static fusion based on the property of SDF. In addition, the influence degree of the light source on the shadow generation for the rendering pixel point may be known by using the illumination intensity ratio information determined based on the directed distance, and then the influence of the light source on the illumination percentage of the rendering pixel point needing illumination rendering in the virtual scene may be known, which supports the generation of the soft shadow effect. Furthermore, when offline, for a static blocking object, the corresponding SDF static map is generated offline; and for a dynamic blocking object, the dynamic blocking object is bound with the corresponding physical entity, realizing dynamic-static separation, thus further improving the calculation speed of the GPU on the illumination region.

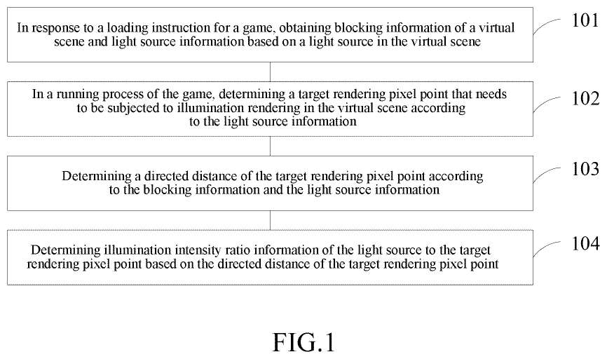

Referring to FIG. 1, FIG. 1 shows a flowchart of steps of a method for generating a soft shadow according to some embodiments of the present disclosure. The method may include the following steps.

In step 101, in response to a loading instruction for a game, blocking information of a virtual scene and light source information based on a light source in the virtual scene are obtained.

The virtual scene in the game may consist of a plurality of unit regions (i.e., Room) in the game, the Rooms may be connected to each other, but the Rooms are independent of each other. There may usually be a plurality of blocking objects in a single Room. The light source in the virtual scene illuminates the surrounding object in a case of no blocking, and a shadow needs to be generated in a case that the light source is blocked. In order to increase the authenticity of the shadow, a soft shadow with a gradual transition is usually used for the generated shadow.

In this case, in order to generate the soft shadow with the gradual transition, it is need to obtain the light source information of the light source in the virtual scene and the blocking information of the virtual scene.

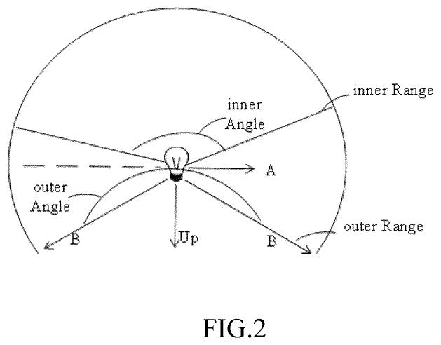

In some embodiments, the generation of the soft shadow is due to the fact that the light source has a certain area, and a half-shadow region is generated where it is not fully illuminated. The light source information of the light source is information defined for the light source, which is essentially defined for the illumination region of the light source. For example, as shown in FIG. 2, the region above the line A may be an illumination region fully illuminated by the light source, the region between the line A and the line B may be a half-shadow region, and the region below the two lines B may be a full-shadow region below.

When the light source is defined, in addition to defining the illumination region, the parameters of the light source, such as the light source identifier, the relative offset information, various angles, various illumination ranges, the light source radius, the illumination color, the illumination intensity, or the like, may also be defined.

In some embodiments, the light source identifier (i.e. ID) is the unique identifier of the light source. It is not allowed that there is repeated light source identifiers in the virtual scene, so that traversal may be performed based on light source identifier during the subsequent calculation of the illumination intensity ratio information of the rendering pixel point for each light source. The relative offset information (i.e. Offset) of the light source refers to the relative offset information of the light source attached to the light source rigid body. The light source is usually attached to the rigid body (i.e. Body, which is defined in the physical engine Box2d), the light source rigid body may be represented as a physical entity in the user vision of the game scene, and the relative offset information of the light source is mainly used to determine the position of the light source, where an offset of Offset is performed mainly based on the center of the Body, and the format of the Offset may usually be represented as x, y. The format of the illumination color (i.e. Color) may be represented as R, G, and B, and the value range of each component is 0 to 255. The light source radius (i.e. Radius), may not be directly reflected in the lighting effect, but may affect the size of the half-show region when blocking is turned on, where the larger the light source radius is, the larger the half-shadow region generated when the light source is close to the blocking object is. When the light source radius is configured, it should be noted that the size of the light source radius is needed to be controlled so as to prevent the light source from entering the blocking range. The blocking range in the embodiments of the present disclosure may refer to not penetrating into the negative region of the SDF, that is, not penetrating into the object. The value of the Radius is usually greater than 0, and the unit may be the physical world unit in Box2d. The illumination intensity (i.e. Intensity) may directly affect the intensity of the illumination effect, and the value of the illumination intensity is usually greater than 0. The glimmer intensity (i.e. Glimmer Intensity) may be represented as that when the illumination region is blocked, the blocked part does not appear the same as the non-illumination region, but glimmer illumination may be generated. The value of the glimmer intensity may also affect the light-receiving effect, and the value range of the glimmer intensity is 0 to 1.

And, as shown in FIG. 2, the upward direction (i.e. Up) of the light source may be defined as that, when the light source does not perform illumination in all directions, the reverse direction of the upward direction may be taken as the middle illumination direction, and other illumination directions may be defined according to the format of (x, y), which does not need to be standardized. For example, (0,1) may be used to define an upward illumination direction, (−1,0) may be used to define a leftward illumination direction, and (1,1) may be used to define an up-rightward illumination direction. The inner Angle refers to an internal angle, the illumination intensity of the region within the internal angle is not attenuated, the illumination orientation bisects the angle, and the value range may be 0 to 360. The outer Angle refers to an external angle, the illumination intensity of the region between the inside and outside of this angle is not attenuated, the region outside this angle is free of illumination, the illumination orientation bisects this angle, the value is 0 to 360, and the outer Angle should be greater than or equal to the inner Angle. The inner Range refers to the internal illumination range, the illumination intensity of the region within the illumination range is not attenuated, the value of the inner Range is usually greater than 0, and the unit may be the physical world unit in Box2D. The outer Range refers to the external illumination range, the illumination intensity of the region outside this illumination range is not attenuated, the region outside the illumination range is free of illumination, the value of the outer Range is usually greater than 0, the unit may be the physical world unit in Box2D, and the outer Range should be greater than or equal to the inner Range.

However, there may be a plurality of blocking objects in the virtual scene, most of the blocking objects in a Room are static, but there are few dynamic blocking objects. The obtained blocking information may include static blocking information corresponding to the static blocking object and dynamic blocking information corresponding to the dynamic blocking object. In some embodiments, the static blocking object is usually a stationary blocking object, such as a stationary geometry and a scene decoration in a fixed platform, and some stationary geometries configured or marked by planners. The static blocking information corresponding to the static blocking object may be generated offline. Usually, by taking a Room as a unit, an SDF static map may be generated for the static blocking object as the static blocking information. For example, the geometry in the Room is converted into an SDF map according to the relative position of the geometry, and the map may be mapped to the Room. The dynamic blocking object generally refers to a mobile platform or other operable objects, and currently supports some basic primitives, such as rectangular, circular, etc. The dynamic blocking information corresponding to the dynamic blocking object may refer to dynamic position and rotation information, etc. The dynamic position and rotation information may be related to the primitives of the dynamic blocking object. For example, the description of the rectangle includes the center point, the length and the width, and the description of the circle includes a circle center and the radius.

In step 102, in a running process of the game, a target rendering pixel point that needs to be subjected to illumination rendering in the virtual scene is determined according to the light source information.

The generation of the soft shadow is mainly based on different illumination intensities of the light source in the virtual scene for the target rendering pixel point that needs to be subjected to illumination rendering, that is, the illumination intensity ratio information. After the light source information and the blocking information for determining the illumination intensity ratio information are obtained, it is also needed to determine the target rendering pixel point that needs to be subjected to illumination rendering in the virtual scene.

In some embodiments, if no light source exists in the current view field of the virtual scene, it is not needed to perform illumination rendering processing on the current screen frame based on the perspective of the virtual player, and it is also not needed to perform illumination rendering processing on the rendering pixel point that is not within the range of the light source radius.

In some embodiments, when the target rendering pixel point is determined, firstly, the position of the light source may be determined by using the relative offset information of the light source attached to the light source rigid body; and then, the bounding box for the light source may be generated based on the position information of the light source, so as to determine the target screen frame according to the bounding box for the light source. In some embodiments, the target screen frame that needs to be subjected to illumination rendering in the virtual scene may be obtained by using the bounding box for the light source. In the determined target screen frame that needs to be subjected to illumination rendering, all rendering pixel pints within the range of the light source radius are determined as the target rendering pixel points that need to be subjected to illumination rendering. It should be noted that, since the determined target rendering pixel points are all rendering pixel points within the range of the light source radius, when the directed distance is determined and the illumination intensity ratio information is calculated subsequently, it is not only needed to perform calculation for each light source in sequence, but also needed to perform calculation for the target rendering pixel point affected by each light source.

In step 103, a directed distance of the target rendering pixel point is determined according to the blocking information and the light source information.

In the embodiments of the present disclosure, the light source information is usually configured in the virtual scene. In the process of responding to the loading instruction of the game and running the game, after the blocking information and the light source information are read and processed, the blocking information and the light source information may also be transmitted into the shader to perform illumination and shadow operations.

In some embodiments, when the calculation of the illumination region is actually performed in the GPU, the related SDF static map and the related dynamic blocking description may be input into the GPU. After the fusion of the dynamic blocking information and the static blocking information is implemented, the illumination and shadow of the target rendering pixel point are calculated based on the SDF algorithm.

In some embodiments, the directed distance of the target rendering pixel point may be determined based on the blocking information and the light source information that are input. The determined directed distance is not only related to the light source factor, but also related to the blocking object factor, which may objectively evaluate the influence of the light source on the illumination intensity of the target rendering pixel point, thus affecting the shadow generation effect.

In step 104, illumination intensity ratio information of the light source to the target rendering pixel point is determined based on the directed distance of the target rendering pixel point.

The determined directional distance of the target rendering pixel point is not only related to the light source factor, but also related to the blocking object factor. In this case, the illumination intensity ratio information of the light source to the target rendering pixel point may be determined based on the directed distance of the target rendering pixel point.

In some embodiments, the determined illumination intensity ratio information may be used to indicate the influence degree of the light source on the shadow generation for the rendering pixel point. The influence degree of the light source on the shadow generation for the rendering pixel point is known based on the illumination intensity ratio information determined according to the directed distance, and then the influence of the light source on the illumination percentage of the rendering pixel point that needs to be subjected to illumination rendering in the virtual scene is known, which supports the generation of the soft shadow effect.

In the embodiments of the present disclosure, when the game is loaded, the blocking information and the light source information of the virtual scene may be obtained; and, in the running process of the game, the target rendering pixel point needing to be subjected to illumination rendering in the virtual scene may be determined based on the light source information, so as to determine the directed distance of the target rendering pixel point according to the blocking information and the light source information. Thus, the illumination intensity ratio information of the light source to the target rendering pixel point may be determined based on the directed distance of the target rendering pixel point, the influence degree of the light source on shadow generation for the rendering pixel point may be known by using the illumination intensity ratio information determined based on the directed distance, and then the influence of the light source on the illumination percentage of the rendering pixel point needing illumination rendering in the virtual scene is known, which supports the generation of the soft shadow effect.

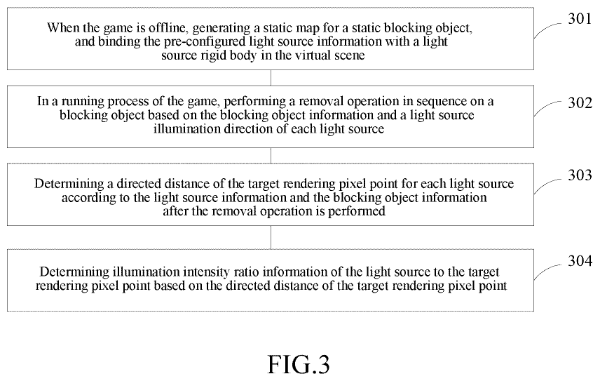

Referring to FIG. 3, FIG. 3 shows a flowchart of steps of a method for generating a soft shadow according to some embodiments of the present disclosure, and the method may include the following steps.

In step 301, when the game is offline, a static map for a static blocking object is generated, and the pre-configured light source information is bound with a light source rigid body in the virtual scene.

When the game is offline, in order to generate a soft shadow having a gradual transition, the light source in the virtual scene may be configured. In addition to the light source, the blocking information may also be configured.

For the configuration of the static blocking information, the static blocking object is usually a stationary blocking object, such as a stationary geometry and a scene decoration in a fixed platform, and some stationary geometries configured or marked by planners. During configuration, usually by taking a Room as a unit, the static blocking object included in the Room may usually be baked in the form of SDF into a static map to serve as the static blocking information, where one Room corresponds to one map. For example, the geometry in the Room is converted into an SDF map according to the relative position of the geometry, and the map may be mapped to the Room. In a specific implementation, a unit region of the virtual scene and a static blocking object in each unit region may be obtained, and a sampling grid for the static blocking object in each unit region may be generated. The sampling grid refers to a sampling grid (i.e. a directed distance field SDF) closest to the surface of the object (i.e. a polygon model). Then, the sampling grid is stored in a corresponding static map, so that the blocking information of the virtual scene can be read by using the static map subsequently in response to a loading instruction for the game.

For the configuration of the dynamic blocking information, the dynamic blocking object generally refers to a mobile platform or other operable objects, and the dynamic blocking information corresponding to the dynamic blocking object may refer to dynamic position and rotation information, etc. Most of the blocking objects have their physical entities. During configuration, the pre-configured light source information may be bound with the light source rigid body in the virtual scene by using the scene editor. The light source rigid body may be represented as a physical entity in the user vision of the game scene. The light source rigid body may refer to a rigid body to which the light source is attached, so that the corresponding dynamic blocking information may be retrieved by using the dynamic blocking rigid body in the virtual scene subsequently.

For the configuration of the light source information, the light source information may be information defined for the light source. Not only the illumination region of the light source may be defined, but also parameters of the source may be defined, such as the light source identifier, the relative offset information, various angles, various illumination ranges, the light source radius, the illumination color, the illumination intensity, or the like. There is usually a physical entity in the virtual scene for the light source. During configuration, it may be represented as that, the pre-configured light source information is bound with the light source rigid body in the virtual scene by using the scene editor. The light source rigid body may be represented as a physical entity in the user vision of the game scene. The light source rigid body may refer to a rigid body to which the light source is attached, so that the corresponding dynamic blocking information may be retrieved by using the dynamic blocking rigid body in the virtual scene subsequently.

In step 302, in a running process of the game, a removal operation is performed in sequence on a blocking object based on the blocking object information and a light source illumination direction of each light source.

In the process of responding to the loading instruction of the game and running the game, the blocking information and the light source information may be read and processed. For example, the corresponding entity is generated, the AABB is calculated, and an operation such as spatial structure management is performed. Then, after the game runs, a transformation from the local space to the world space may be performed on all objects in the scene. In this case, it may be determined whether a light source is present in the current view field by using the ABAB of the light source. In a case that at least one light source is present in the current view field, it is needed to remove the blocking object sequentially based on each light source.

In some embodiments, the removal operation may be performed in sequence on the blocking object based on the blocking object information and the light source illumination direction of each light source, to obtain the blocking object information after the removal operation is performed. In the performed removal operation, substantially, only the dynamic blocking object is processed. Since the static blocking object is obtained based on reading of the map, the removal operation may not be performed on the static blocking object.

In some embodiments, a bounding box for each light source may be generated, and a dynamic blocking object intersecting with the bounding box of each light source may be obtained respectively. Then, the dynamic blocking object that is not in the illumination direction of each light source may be removed from the dynamic blocking object intersecting with the bounding box of each light source, to obtain the blocking object information after the removal operation. In some embodiments, for each light source, all dynamic blocking objects intersecting with the AABB of the light source may be obtained; since the light source may not illuminate in all directions, the illumination direction may be of a fan shape; in this case, it is also needed to remove the blocking object that intersects with the AABB and is actually located in an illumination gap based on the illumination direction of the light source. After all visible light sources have been processed, the union of all selected blocking objects may be taken as the final dynamic blocking objects that need to be processed. In some embodiments, since the removal operation is not performed on the static blocking object, the blocking object information after the removal operation may include the dynamic blocking object information after the removal operation and the static blocking object information before the removal operation.

It should be noted that the removal operation performed on the dynamic blocking object is updated for each frame, thus overcoming the relative change between each frame of light source and the blocking position.

After the removal processing is performed, the dynamic blocking object information after the removal operation and the light source information may be stored in the processing structure, and the SDF static map of the Room may also be stored in the processing structure, so that the execution entity for the subsequent work is converted from the CPU to the GPU. For example, due to the characteristics of the game, for a Room, even if processing of the next room is added, at most two SDF maps are used, that is, the SDF static map stored in the processing structure includes two maps.

In step 303, a directed distance of the target rendering pixel point for each light source is determined according to the light source information and the blocking object information after the removal operation is performed.

During rendering, the content stored in the processing structure may be transmitted to the GPU, so that the GPU performs subsequent calculation. Then, the illumination region of the target rendering pixel point may be calculated based on the light source information and the blocking object information after the removal operation is performed.

In some embodiments, the generation of the soft shadow is mainly based on different illumination intensities of the light source in the virtual scene for the target rendering pixel point that needs to be subjected to illumination rendering, that is, the illumination intensity ratio information. After the blocking information and the light source information for determining the illumination intensity ratio information are obtained, it is further needed to determine the target rendering pixel point that needs to be subjected to illumination rendering in the virtual scene.

In some embodiments, if no light source is present in the current view field of the virtual scene, it is not needed to perform illumination rendering processing on the current screen frame based on the perspective of the virtual player, and it is also not needed to perform illumination rendering processing on the rendering pixel point that is not within the range of the light source radius.

Therefore, when the target rendering pixel point is determined, the position of the light source may first be determined by using the relative offset information of the light source attached to the light source rigid body; and then, it may be determined, by using the AABB of the light source, whether the light source is present in the current view field of the virtual scene. In some embodiments, the bounding box AABB for the light source may be generated based on the position information of the light source, and the virtual scene may also be regarded as a bounding box AABB. In this case, it may be determined, based on the intersection of two AABBs, whether the light source is present in the current visual field of the virtual scene. If there is an intersection part between the two ABBs, which indicates that the light source is present in the current view field, it is determined that the illumination rendering needs to be performed on the current screen frame of the virtual scene, and the target screen frame that needs to be subjected to illumination rendering in the virtual scene may be obtained.

Then, in the determined target screen frame that needs to be subjected to illumination rendering, all rendering pixel points within the range of the light source radius may be determined as the target rendering pixel points that need to be subjected to illumination rendering. It should be noted that, since the determined target rendering pixel points are all rendering pixel points within the range of the light source radius, when the directed distance is determined and the illumination intensity ratio information is calculated subsequently, it is not only needed to perform calculation for each light source in sequence, but also needed to perform calculation for the target rendering pixel point affected by each light source.

In some embodiments, the GPU may receive information transmitted by the CPU based on the processing structure. In this case, it may be simply determined whether the distance from the current rendering pixel point to the light source is within the range of the light source radius, so as to exclude some pixels more quickly. That is, if the distance from the current rendering pixel point to the light source is not within the range of the light source radius, it may be directly determined that the current rendering pixel point is in the full-shadow region, and the current rendering pixel point is directly excluded.

In some embodiments of the present disclosure, when the directed distance of the target rendering pixel point for each light source is calculated, for each light source, the target rendering pixel point may be moved towards the position of the light source in a preset step size, and the directed distance of the target rendering pixel point after movement may be determined based on the blocking object information after the removal operation. In some embodiments, if the directed distance reaches a preset distance threshold, the target rendering pixel point may be continuously moved again towards the position of the light source by taking the directed distance as a step size, and the directed distance of the target rendering pixel point after movement may be determined again based on the blocking object information after the removal operation until the target rendering pixel point is moved to the position of the light source, so as to reduce the error.

In some embodiments, when the directed distance of the target rendering pixel point after movement is determined based on the blocking object information after the removal operation, a first minimum directed distance value may be obtained from the dynamic blocking object information after the removal operation by traversing the target rendering pixel point after movement, and then, a second minimum directed distance value may be obtained by performing sampling on the static map corresponding to the target rendering pixel point after movement. In this case, a smaller value in the first minimum directed distance value and the second minimum directed distance value may be determined as the directed distance of the target rendered pixel point after movement.

In step 304, illumination intensity ratio information of the light source to the target rendering pixel point is determined based on the directed distance of the target rendering pixel point.

The determined directional distance of the target rendering pixel point is not only related to the light source factor, but also related to the blocking object factor. In this case, the illumination intensity ratio information of the light source to the target rendering pixel point may be determined based on the directed distance of the target rendering pixel point.

In some embodiments, the determined illumination intensity ratio information may be used to indicate the influence degree of the light source on the shadow generation for the rendering pixel point. The influence degree of the light source on the shadow generation for the rendering pixel point is known based on the illumination intensity ratio information determined according to the directed distance, and then the influence of the light source on the illumination percentage of the rendering pixel point needing illumination rendering in the virtual scene is known, which supports the generation of the soft shadow effect.

In some embodiments, the light source radius of the light source may be obtained, and the ratio of the directed distance of the target rendering pixel point to the light source radius may be calculated to obtain the illumination intensity ratio information of the target rendering pixel point.

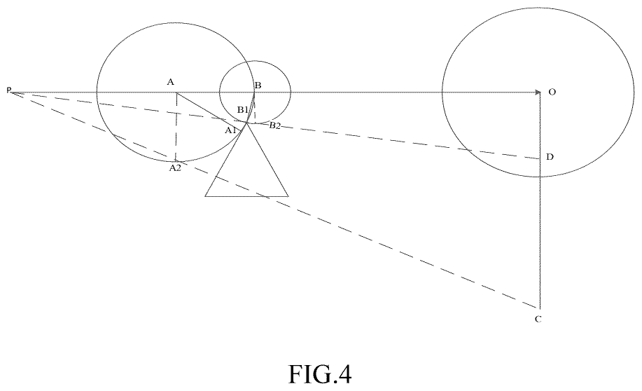

For example, referring to FIG. 4, FIG. 4 shows a schematic diagram of generating illumination intensity ratio information provided according to some embodiments of the present disclosure. It is assumed that P is a current target rendering pixel point, O is the position of a light source, the light source radius is r, the triangular portion is a blocking object, and the blocking object may be a static blocking object or a dynamic blocking object. In this case, the illumination influence of the P point may be represented as making two tangent lines of the circle of the light source O that pass the P point, and the corresponding diameter may be used approximately in the embodiments of the present disclosure.

In this case, the target rendering pixel point may be moved from the point P towards the O in a small initial step size (i.e. the preset step size). Assuming that the point A is reached, that is, the target rendering pixel point after movement is the point A, the directed distance of the point A (i.e. the SDF value) may be obtained by using the SDF function, so as to serve as the length of AA1.

The dynamic blocking and the static blocking may be fused by obtaining the SDF value. In this case, the first minimum directed distance value min1 may be obtained by performing traversal on the SDF descriptions of all the dynamic blocking objects and the point A, and then the second minimum directed distance value min2 may be obtained by performing sampling on the SDF static map corresponding to the point A. In this case, the minimum value in the first minimum directed distance value min1 and the second minimum directed distance value min2 may be taken as the SDF of the point.

The preset distance threshold is usually −r. In one case, if the obtained directed distance value SDF is less than the preset distance threshold, it indicates that the target rendering pixel point is completely in the shadow, and then, the algorithm may be exited to determine the illumination intensity ratio of another target rendering pixel point.

In another case, if the obtained directional distance value SDF reaches the preset distance threshold, the algorithm continues. In this case, AA1 may be regarded as AA2, and ∥PA∥/∥PO∥=∥AA2∥/∥OC∥. Since all other quantities except OC are known, in this case, the ratio of the directed distance of the target rendering pixel point to the light source radius, i.e., the ratio of OC to r, may be calculated as the illumination intensity ratio information of the target rendering pixel point. However, since there is a large error in this approximation, the smaller the SDF is, the purpose of reducing the error may be achieved.

In some embodiments, for the same target rendering pixel point, the length of AA1 (that is, the directed distance obtained by calculating during the last movement) may also be used as the step size to move the target rendering pixel point towards O again. If the value of the directed distance is too small, the length of one pixel may also be used as the step size. Assuming that the target rendering pixel point after movement reaches the new point B, a smaller coverage value OD than OC may be obtained by using the same operation as that performed after the point A is reached. Then, the length of BB1 is used as the step size to move the target rendering pixel point towards O again, until the O point is reached. Alternatively, after a certain number of steps, the movement of the target rendering pixel point is stopped. The obtained minimum coverage value is used as the directed distance of the target rendering pixel point, so as to obtain the illumination intensity ratio information of the target rendering pixel point by using the ratio of the directed distance of the target rendering pixel point to the light source radius.

It should be noted that, in the step of calculating the coverage value shown in FIG. 4, only half of the light source is considered. After the minimum coverage value is obtained, the illumination intensity ratio information finally for the target rendering pixel point is obtained by adding r to the coverage value, then performing normalization and cutting it out to [0, 1]. In order to achieve a softer transition effect, a smooth step operation may be performed on the illumination result based on the illumination intensity ratio information.

In some embodiments, after the calculation of all light sources is completed, the algorithm ends. The final result obtained at this time will influence the illumination percentage subsequently, thus generating a shadow effect.

In the embodiments of the present disclosure, when the game is loaded, the blocking information and the light source information of the virtual scene may be obtained; and, in the running process of the game, the target rendering pixel point needing to be subjected to illumination rendering in the virtual scene may be determined based on the light source information, so as to determine the directed distance of the target rendering pixel point according to the blocking information and the light source information. Thus, the illumination intensity ratio information of the light source to the target rendering pixel point may be determined based on the directed distance of the target rendering pixel point, the influence degree of the light source on shadow generation for the rendering pixel point may be known by using the illumination intensity ratio information determined based on the directed distance, and then the influence of the light source on the illumination percentage of the rendering pixel point needing illumination rendering in the virtual scene is known, which supports the generation of the soft shadow effect.

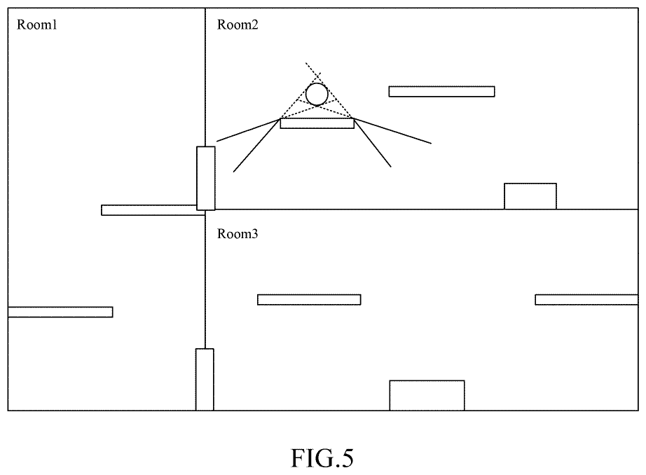

Referring to FIG. 5, FIG. 5 shows a schematic diagram of an application scenario of soft shadow generation provided according to some embodiments of the present disclosure. The game that is loaded and run may be a platform jumping game. The virtual scene in the game may consist of a plurality of unit regions (Room) in the game, the Rooms may be connected to each other, but the Rooms are independent of each other. There may usually be a plurality of blocking objects in a single Room. Although these blocking objects are different from the platform, and most of them are static, there are few dynamic blocking objects. The light source in the virtual scene illuminates the surrounding object in a case of no blocking, and a shadow needs to be generated in a case that the light source is blocked. In order to increase the authenticity of the shadow, a soft shadow with a gradual transition is usually used for the generated shadow.

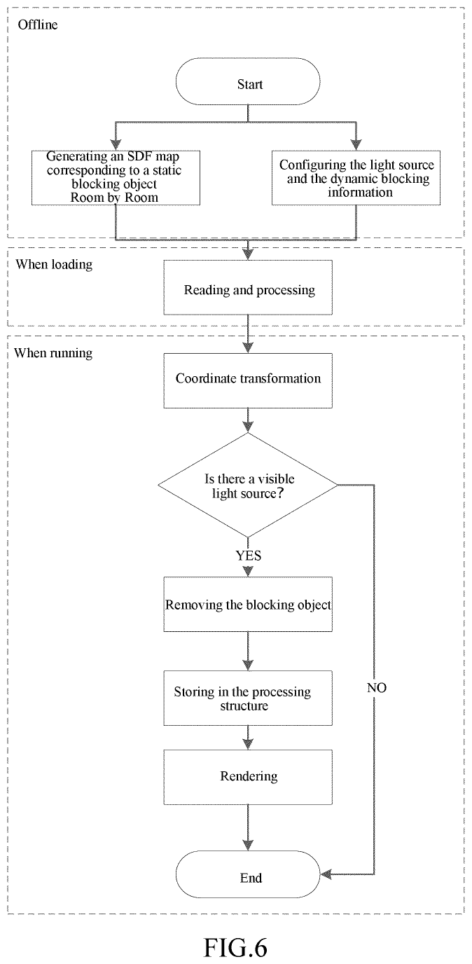

In some embodiments, referring to FIG. 6, FIG. 6 shows a schematic diagram of a process of generating a soft shadow provided according to some embodiments of the present disclosure, in which, for a dynamic blocking object, it is mainly used to bind a blocking object with a physical entity. For a static blocking object, usually, a corresponding SDF map is generated offline by taking the Room as a unit; and during subsequent actual calculation in the GPU, the description for the dynamic blocking object and the static SDF map for the staic blocking object are fused, and illumination and shadow are calculated by using an SDF-based algorithm, so as to generate a soft shadow.

In some embodiments, during offline, the static blocking information included in each room may be baked in the form of SDF to the map, and the light source information and the dynamic blocking information may be bound with the physical entity by using the scene editor. Then, when the game is loaded, information generated and configured during offline may be read. In the running process, when the object in the scene is transformed from the local space to the world space, if there is one or more light sources, removal of the blocking object is performed on each light source in sequence, and then the illumination information and the blocking object information are stored in the processing structure. During rendering, the content in the processing structure will be delivered to the GPU for subsequent calculation of the illumination region by the GPU, where the operation of storing the information in the processing structure may be a main working process of execution entity conversion from the CPU to the GPU.

For the calculation by the GPU, the illumination intensity ratio information of the light source to the target rendering pixel point may be determined based on the directed distance of the target rendering pixel point, and the influence degree of the light source on the shadow generation for the rendering pixel point is known based on the illumination intensity ratio information determined according to the directed distance. In some embodiments, the ratio of the directed distance of the target rendering pixel point to the light source radius may be calculated to obtain the illumination intensity ratio information of the target rendering pixel point, and then the influence of the light source on the illumination percentage of the rendering pixel point needing illumination rendering in the virtual scene is known, which supports the generation of the soft shadow effect.

In the embodiments of the present disclosure, there is proposed a solution implemented based on the GPU, which is fast, stable, and supports soft shadow. Mainly in the solution, calculation of the illumination region of the light source may be performed based on the obtained blocking information and the light source information during rendering, and since the GPU needs to perform less logic while performing the calculation of the illumination region, the calculation speed may be improved by performing the calculation operation of the illumination region based on the GPU. Moreover, the directed distance of the target rendering pixel point may be determined based on the blocking information and the light source information, and then the illumination intensity ratio information of the light source to the target rendering pixel point may be determined; and in this manner, due to the simple algorithm property for the directed distance, various complex situations do not need to be considered, and it is convenient for dynamic-static fusion based on the property of SDF. In addition, the influence degree of the light source on the shadow generation for the rendering pixel point may be known by using the illumination intensity ratio information determined based on the directed distance, and then the influence of the light source on the illumination percentage of the rendering pixel point needing illumination rendering in the virtual scene may be known, which supports the generation of the soft shadow effect. Furthermore, when offline, for a static blocking object, the corresponding SDF static map is generated offline; and for a dynamic blocking object, the dynamic blocking object is bound with the corresponding physical entity, realizing dynamic-static separation, thus further improving the calculation speed of the GPU on the illumination region.

It should be noted that, for the method embodiments, for simplicity of description, the method embodiments are expressed as a series of action combinations, but those skilled in the art should be aware that the embodiments of the present disclosure are not limited by the described action sequence, because some steps may be performed in other orders or simultaneously according to the embodiments of the present disclosure. Secondly, those skilled in the art should also know that the embodiments described in the description are all preferred embodiments, and the involved actions are not necessarily required by the embodiments of the present disclosure.

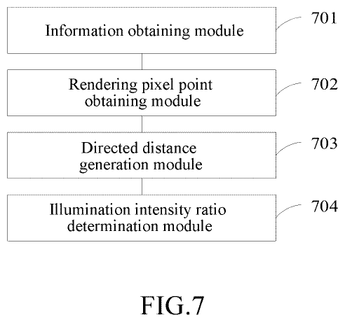

Referring to FIG. 7, FIG. 7 shows a structural block diagram of an apparatus for generating a soft shadow according to some embodiments of the present disclosure. The apparatus may include the following modules: an information obtaining module 701, a rendering pixel point obtaining module 702, a directed distance generation module 703, and an illumination intensity ratio determination module 704.

The information obtaining module 701 is configured to, in response to a loading instruction for a game, obtain blocking information of a virtual scene and light source information based on a light source in the virtual scene.

The rendering pixel point obtaining module 702 is configured to, in a running process of the game, determine a target rendering pixel point that needs to be subjected to illumination rendering in the virtual scene according to the light source information.

The directed distance generation module 703 is configured to determine a directed distance of the target rendered pixel point according to the blocking information and the light source information.

The illumination intensity ratio determination module 704 is configured to determine illumination intensity ratio information of the light source to the target rendering pixel point based on the directed distance of the target rendering pixel point, where the illumination intensity ratio information is used to indicate an influence degree of the light source on shadow generation for the rendering pixel point.

According to the apparatus for generating a soft shadow provided by the embodiments of the present disclosure, when the game is loaded, the blocking information and the light source information of the virtual scene may be obtained; and, in the running process of the game, the target rendering pixel point needing to be subjected to illumination rendering in the virtual scene may be determined based on the light source information, so as to determine the directed distance of the target rendering pixel point according to the blocking information and the light source information. Thus, the illumination intensity ratio information of the light source to the target rendering pixel point may be determined based on the directed distance of the target rendering pixel point, the influence degree of the light source on shadow generation for the rendering pixel point may be known by using the illumination intensity ratio information determined based on the directed distance, and then the influence of the light source on the illumination percentage of the rendering pixel point needing illumination rendering in the virtual scene is known, which supports the generation of the soft shadow effect.

In some embodiments of the present disclosure, the blocking information includes static blocking information and dynamic blocking information generated offline, and the apparatus may further include the following modules: a static map generation module and a rigid body binding module.

The static map generation module is configured to: when the game is offline, obtain a unit region of the virtual scene and a static blocking object in each unit region, generate a sampling grid for the static blocking object in each unit region, and store the sampling grid in a corresponding static map.

The rigid body binding module is configured to, when the game is offline, bind the pre-configured light source information with a light source rigid body in the virtual scene.

According to the modules provided in the above embodiments, the soft shadow with gradual transition may be generated when the game is offline, to increase the authenticity of the shadow. The unit region of the virtual scene and the static blocking object in each unit region may be obtained, the sampling grid for the static blocking object in each unit region may be generated, and the sampling grid may be stored in the corresponding static map, so that the blocking information of the virtual scene may be read by using the static map in the subsequent response to the loading instruction for the game.

In some embodiments of the present disclosure, the information obtaining module 701 may include the following sub-module: an information obtaining sub-module.

The information obtaining sub-module is configured to read the blocking information of the virtual scene by using the static map, retrieve corresponding light source information by using the light source rigid body in the virtual scene, and retrieve corresponding dynamic blocking information by using a dynamic blocking rigid body in the virtual scene.

According to the above information obtaining module, the obtained blocking information may include static blocking information corresponding to the static blocking object and dynamic blocking information corresponding to the dynamic blocking object. Then, the retrieved light source information and the dynamic blocking information may be stored into the processing structure, and the static map may also be stored in the processing structure simultaneously, so that the subsequent execution entity is converted from the CPU to the GPU.

In some embodiments of the present disclosure, the light source information includes a light source radius and relative offset information of the light source attached to the light source rigid body. The rendering pixel point obtaining module 702 may include the following sub-modules: a light source position determination sub-module, a target screen frame obtaining sub-module, and a target rendering pixel point determination sub-module.

The light source position determination sub-module is configured to determine a position of the light source by using the relative offset information of the light source attached to the light source rigid body.

The target screen frame obtaining sub-module is configured to generate a bounding box for the light source based on the position of the light source, and determine a target screen frame according to the bounding box of the light source.

The target rendering pixel point determination sub-module is configured to determine, in the target image frame, a rendering pixel point within a range of the light source radius as the target rendering pixel point that needs to be subjected to illumination rendering.

According to the above rendering pixel point obtaining module, when the target rendering pixel point is determined, it may be determined whether a light source is present in the current view field, and then, the target rendering pixel point that needs to be subjected to illumination rendering is determined when the light source is present, so that some pixel points are excluded, which is convenient for subsequent generation of the soft shadow effect.

In some embodiments of the present disclosure, the virtual scene includes at least one light source, and the light source information includes a light source illumination direction. The directed distance generation module 703 may include the following sub-modules: a blocking object removing sub-module, and a directed distance determination sub-module.

The blocking object removing sub-module is configured to perform a removal operation in sequence on a blocking object based on the blocking object information and a light source illumination direction of each light source to obtain blocking object information after the removal operation.

The directed distance determination sub-module is configured to determine the directed distance of the target rendering pixel point for each light source according to the light source information and the blocking object information after the removal operation.

According to the above directed distance generation module, in the removal operation, substantially, only the dynamic blocking object is processed. Since the static blocking object is obtained based on reading of the map, the removal operation may not be performed on the static blocking object. In some embodiments of the present disclosure, the blocking object removing sub-module may include the following units: a bounding box generation unit and a blocking object removing unit.

The bounding box generation unit is configured to generate a bounding box for each light source, and obtain a dynamic blocking object intersecting with the bounding box of each light source, respectively.

The blocking object removing unit is configured to obtain the blocking object information after the removal operation by removing a dynamic blocking object that is not in a light source illumination direction of each light source from the dynamic blocking object intersecting with the bounding box of each light source, where the blocking object information after the removal operation includes the blocking object information after the removal operation and static blocking object information before the removal operation.

According to the above blocking object removing sub-module, since the light source may not illuminate in all directions, the illumination direction may be of a fan shape. In this case, it is also needed to remove the blocking object that intersects with the AABB and is actually located in an illumination gap based on the illumination direction of the light source, so as to remove the dynamic blocking object not in the light source illumination direction of each light source, which is convenient for subsequent generation of the soft shadow effect.

In some embodiments of the present disclosure, the light source information includes a position of the light source, where the position of the light source is based on the relative offset information of the light source attached to the light source rigid body. The directed distance determination sub-module may include the following units: a directed distance determination unit, and a re-moving unit.

The directed distance determination unit is configured to, for each light source, move the target rendering pixel point towards the position of the light source in a preset step size, and determine a directed distance of the target rendering pixel point after movement based on the blocking object information after the removal operation.

The re-moving unit is configured to, when the directed distance reaches a preset distance threshold, continuously move the target rendering pixel point towards the position of the light source again by taking the directed distance as a step size, and determine a directed distance of the target rendering pixel point after movement again based on the blocking object information after the removal operation, until the target rendering pixel point is moved to the position of the light source.

According to the above directed distance generation module, the directed distance of the target rendering pixel point after movement is determined based on the blocking object information after the removal operation, until the target rendering pixel point is moved to the position of the light source, so as to reduce the error.

In some embodiments of the present disclosure, the blocking object information after the removal operation includes dynamic blocking object information after the removal operation and static blocking object information before the removal operation. The directed distance determination unit may include the following sub-units: a first minimum directed distance value obtaining sub-unit, a second minimum directed distance value obtaining sub-unit, and a directed distance determining sub-unit.

The first minimum directed distance value obtaining sub-unit is configured to obtain a first minimum directed distance value from the dynamic blocking object information after the removal operation by traversing the target rendering pixel point after movement.

The second minimum directed distance value obtaining sub-unit is configured to obtain a second minimum directed distance value by performing sampling on a static map corresponding to the target rendering pixel point after movement.

The directed distance determining sub-unit is configured to determine a smaller value in the first minimum directed distance value and the second minimum directed distance value as the directed distance of the target rendered pixel point after movement.

In some embodiments of the present disclosure, the illumination intensity ratio determination module 704 may include the following sub-modules: an illumination intensity ratio calculation sub-module.

The illumination intensity ratio calculation sub-module is configured to obtain a light source radius of the light source, and obtain the illumination intensity ratio information of the target rendered pixel point by calculating a ratio of the directed distance of the target rendered pixel point to the light source radius.

According to the above illumination intensity ratio determination module 704, the determined illumination intensity ratio information may be used to indicate the influence degree of the light source on the shadow generation for the rendering pixel point, the influence degree of the light source on the shadow generation for the rendering pixel point is known based on the illumination intensity ratio information determined according to the directed distance, and then the influence of the light source on the illumination percentage of the rendering pixel point needing illumination rendering in the virtual scene is known, which supports the generation of the soft shadow effect.

For the apparatus embodiments, since the apparatus embodiments are basically similar to the method embodiments, the description is relatively simple, and for the relevant parts, reference may be made to the description of the method embodiments.

According to some embodiments of the present disclosure, there is further provided an electronic device.

The electronic device includes a processor, a memory, and a computer program stored in the memory and capable of running on the processor. When the computer program is executed by the processor, various processes of the foregoing embodiments of the method for generating a soft shadow are implemented, and the same technical effect may be achieved.

In response to a loading instruction for the game, blocking information of a virtual scene and light source information based on a light source in the virtual scene are obtained; in a running process of the game, a target rendering pixel point that needs to be subjected to illumination rendering in the virtual scene is determined according to the light source information; a directed distance of the target rendering pixel point is determined according to the blocking information and the light source information; and, illumination intensity ratio information of the light source to the target rendering pixel point is determined based on the directed distance of the target rendering pixel point, where the illumination intensity ratio information is used to indicate an influence degree of the light source on shadow generation for the target rendering pixel point.

According to the above method for generating a soft shadow, when the game is loaded, the blocking information and the light source information of the virtual scene may be obtained; and, in the running process of the game, the target rendering pixel point needing to be subjected to illumination rendering in the virtual scene may be determined based on the light source information, so as to determine the directed distance of the target rendering pixel point according to the blocking information and the light source information. Thus, the illumination intensity ratio information of the light source to the target rendering pixel point may be determined based on the directed distance of the target rendering pixel point, the influence degree of the light source on shadow generation for the rendering pixel point may be known by using the illumination intensity ratio information determined based on the directed distance, and then the influence of the light source on the illumination percentage of the rendering pixel point needing illumination rendering in the virtual scene is known, which supports the generation of the soft shadow effect.

In some embodiments of the present disclosure, the blocking information includes dynamic blocking information and static blocking information generated offline. When the game is offline, a unit region of the virtual scene and a static blocking object in each unit region are obtained, a sampling grid for the static blocking object in each unit region is generated, and the sampling grid is stored in a corresponding static map. When the game is offline, the pre-configured light source information is bound with a light source rigid body in the virtual scene.

According to the above embodiments, the soft shadow with gradual transition may be generated when the game is offline, to increase the authenticity of the shadow. The unit region of the virtual scene and the static blocking object in each unit region may be obtained, the sampling grid for the static blocking object in each unit region may be generated, and the sampling grid may be stored in the corresponding static map, so that the blocking information of the virtual scene may be read by using the static map in the subsequent response to the loading instruction for the game.

In some embodiments of the present disclosure, the step of obtaining the blocking information of the virtual scene and the light source information based on the light source in the virtual scene includes: reading the blocking information of the virtual scene by using the static map, retrieving corresponding light source information by using the light source rigid body in the virtual scene, and retrieving corresponding dynamic blocking information by using a dynamic blocking rigid body in the virtual scene.

According to the above embodiments, the obtained blocking information may include static blocking information corresponding to the static blocking object and dynamic blocking information corresponding to the dynamic blocking object. Then, the retrieved light source information and the dynamic blocking information are stored in the processing structure, and the static map is also stored in the processing structure simultaneously, so that the subsequent execution entity is converted from the CPU to the GPU.

In some embodiments of the present disclosure, the light source information includes a light source radius and relative offset information of the light source attached to the light source rigid body. The determining the target rendering pixel point that needs to be subjected to illumination rendering in the virtual scene according to the light source includes: determining a position of a light source by using the relative offset information of the light source attached to the light source rigid body; generating a bounding box for the light source based on the position of the light source, and determining a target screen frame according to the bounding box of the light source; and determining, in the target screen frame, a rendering pixel point within a range of the light source radius as the target rendering pixel point that needs to be subjected to illumination rendering.

According to the above embodiments, when the target rendering pixel point is determined, it may be determined whether a light source is present in the current view field, and then, the target rendering pixel point that needs to be subjected to illumination rendering is determined when the light source is present, so that some pixel points are excluded, which is convenient for subsequent generation of the soft shadow effect.

In some embodiments of the present disclosure, the virtual scene includes at least one light source, and the light source information includes a light source illumination direction. The determining the directed distance of the target rendering pixel point according to the blocking information and the light source information, includes: performing a removal operation in sequence on a blocking object based on the blocking object information and a light source illumination direction of each light source to obtain blocking object information after the removal operation; and determining the directed distance of the target rendering pixel point for each light source according to the light source information and the blocking object information after the removal operation.

According to the above embodiments, in the removal operation, substantially, only the dynamic blocking object is processed. Since the static blocking object is obtained based on reading of the map, the removal operation may not be performed on the static blocking object.

In some embodiments of the present disclosure, performing the removal operation in sequence on the blocking object based on the blocking object information and the light source illumination direction of each light source to obtain the blocking object information after the removal operation, includes: generating a bounding box for each light source, and obtaining a dynamic blocking object intersecting with the bounding box of each light source respectively; and, obtaining the blocking object information after the removal operation by removing a dynamic blocking object that is not in a light source illumination direction of each light source from the dynamic blocking object intersecting with the bounding box of each light source, where the blocking object information after the removal operation includes dynamic blocking object information after the removal operation and static blocking object information before the removal operation.

According to the above embodiments, since the light source may not illuminate in all directions, the illumination direction may be of a fan shape. In this case, it is also needed to remove the blocking object that intersects with the AABB and is actually located in an illumination gap based on the illumination direction of the light source, so as to remove the dynamic blocking object not in the light source illumination direction of each light source, which is convenient for subsequent generation of the soft shadow effect.

In some embodiments of the present disclosure, the light source information includes a position of the light source, where the position of the light source is based on the relative offset information of the light source attached to the light source rigid body. The determining the directed distance of the target rendering pixel point for each light source according to the light source information and the blocking object information after the removal operation, includes: for each light source, moving the target rendering pixel point towards the position of the light source in a preset step size, and determining a directed distance of the target rendering pixel point after movement based on the blocking object information after the removal operation; if the directed distance reaches a preset distance threshold, continuously moving towards the position of the light source again by taking the directed distance as a step size, and determining a directed distance of the target rendering pixel point after movement again based on the blocking object information after the removal operation until the target rendering pixel point is moved to the position of the light source.

According to the above embodiments, the directed distance of the moving target rendering pixel point is determined based on the blocking object information after the removal operation, until the target rendering pixel point is moved to the position of the light source, so as to reduce the error.

In some embodiments of the present disclosure, the blocking object information after the removal operation includes dynamic blocking object information after the removal operation and static blocking object information before the removal operation. The determining the directed distance of the target rendering pixel point after movement based on the blocking object information after the removal operation, includes: obtaining a first minimum directed distance value from the dynamic blocking object information after the removal operation by traversing the target rendering pixel point after movement; obtaining a second minimum directed distance value by performing sampling on a static map corresponding to the target rendering pixel point after movement; and determining a smaller value in the first minimum directed distance value and the second minimum directed distance value as the directed distance of the target rendered pixel point after movement.

In some embodiments of the present disclosure, determining the illumination intensity ratio information of the light source to the target rendering pixel point based on the directed distance of the target rendering pixel point includes: obtaining a light source radius of the light source, and obtaining the illumination intensity ratio information of the target rendered pixel point by calculating a ratio of the directed distance of the target rendered pixel point to the light source radius.

According to the above embodiments, the determined illumination intensity ratio information may be used to indicate the influence degree of the light source on the shadow generation for the rendered pixel point, and the influence degree of the light source on the shadow generation for the rendered pixel point is known based on the illumination intensity ratio information determined according to the directed distance, and then the influence of the light source on the illumination percentage of the rendering pixel point needing illumination rendering in the virtual scene is known, which supports the generation of the soft shadow effect.

According to some embodiments of the present disclosure, there is further provides a computer-readable storage medium. The computer-readable storage medium stores a computer program, and when the computer program is executed by a processor, various processes of the foregoing embodiments of the method for generating a soft shadow are implemented, and the same technical effect may be achieved.

In response to a loading instruction for the game, blocking information of a virtual scene and light source information based on a light source in the virtual scene are obtained; in a running process of the game, a target rendering pixel point that needs to be subjected to illumination rendering in the virtual scene is determined according to the light source information; a directed distance of the target rendering pixel point is determined according to the blocking information and the light source information; and, illumination intensity ratio information of the light source to the target rendering pixel point is determined based on the directed distance of the target rendering pixel point, where the illumination intensity ratio information is used to indicate an influence degree of the light source on shadow generation for the target rendering pixel point.

According to the above method for generating a soft shadow, when the game is loaded, the blocking information and the light source information of the virtual scene may be obtained; and, in the running process of the game, the target rendering pixel point needing to be subjected to illumination rendering in the virtual scene may be determined based on the light source information, so as to determine the directed distance of the target rendering pixel point according to the blocking information and the light source information. Thus, the illumination intensity ratio information of the light source to the target rendering pixel point may be determined based on the directed distance of the target rendering pixel point, the influence degree of the light source on shadow generation for the rendering pixel point may be known by using the illumination intensity ratio information determined based on the directed distance, and then the influence of the light source on the illumination percentage of the rendering pixel point needing illumination rendering in the virtual scene is known, which supports the generation of the soft shadow effect.

In some embodiments of the present disclosure, the blocking information includes dynamic blocking information and static blocking information generated offline. When the game is offline, a unit region of the virtual scene and a static blocking object in each unit region are obtained, a sampling grid for the static blocking object in each unit region is generated, and the sampling grid is stored in a corresponding static map. When the game is offline, the pre-configured light source information is bound with a light source rigid body in the virtual scene.

According to the above embodiments, the soft shadow with gradual transition may be generated when the game is offline, to increase the authenticity of the shadow. The unit region of the virtual scene and the static blocking object in each unit region may be obtained, the sampling grid for the static blocking object in each unit region may be generated, and the sampling grid may be stored in the corresponding static map, so that the blocking information of the virtual scene may be read by using the static map in the subsequent response to the loading instruction for the game.

In some embodiments of the present disclosure, the step of obtaining the blocking information of the virtual scene and the light source information based on the light source in the virtual scene includes: reading the blocking information of the virtual scene by using the static map, retrieving corresponding light source information by using the light source rigid body in the virtual scene, and retrieving corresponding dynamic blocking information by using a dynamic blocking rigid body in the virtual scene.

According to the above embodiments, the obtained blocking information may include static blocking information corresponding to the static blocking object and dynamic blocking information corresponding to the dynamic blocking object. Then, the retrieved light source information and the dynamic blocking information are stored in the processing structure, and the static map is also stored in the processing structure simultaneously, so that the subsequent execution entity is converted from the CPU to the GPU.

In some embodiments of the present disclosure, the light source information includes a light source radius and relative offset information of the light source attached to the light source rigid body. The determining the target rendering pixel point that needs to be subjected to illumination rendering in the virtual scene according to the light source includes: determining a position of a light source by using the relative offset information of the light source attached to the light source rigid body; generating a bounding box for the light source based on the position of the light source, and determining a target screen frame according to the bounding box of the light source; and determining, in the target screen frame, a rendering pixel point within a range of the light source radius as the target rendering pixel point that needs to be subjected to illumination rendering.

According to the above embodiments, when the target rendering pixel point is determined, it may be determined whether a light source is present in the current view field, and then, the target rendering pixel point that needs to be subjected to illumination rendering is determined when the light source is present, so that some pixel points are excluded, which is convenient for subsequent generation of the soft shadow effect.

In some embodiments of the present disclosure, the virtual scene includes at least one light source, and the light source information includes a light source illumination direction. The determining the directed distance of the target rendering pixel point according to the blocking information and the light source information, includes: performing a removal operation in sequence on a blocking object based on the blocking object information and a light source illumination direction of each light source to obtain blocking object information after the removal operation; and determining the directed distance of the target rendering pixel point for each light source according to the light source information and the blocking object information after the removal operation.

According to the above embodiments, in the removal operation, substantially, only the dynamic blocking object is processed. Since the static blocking object is obtained based on reading of the map, the removal operation may not be performed on the static blocking object.

In some embodiments of the present disclosure, performing the removal operation in sequence on the blocking object based on the blocking object information and the light source illumination direction of each light source to obtain the blocking object information after the removal operation, includes: generating a bounding box for each light source, and obtaining a dynamic blocking object intersecting with the bounding box of each light source respectively; and, obtaining the blocking object information after the removal operation by removing a dynamic blocking object that is not in a light source illumination direction of each light source from the dynamic blocking object intersecting with the bounding box of each light source, where the blocking object information after the removal operation includes dynamic blocking object information after the removal operation and static blocking object information before the removal operation.

According to the above embodiments, since the light source may not illuminate in all directions, the illumination direction may be of a fan shape. In this case, it is also needed to remove the blocking object that intersects with the AABB and is actually located in an illumination gap based on the illumination direction of the light source, so as to remove the dynamic blocking object not in the light source illumination direction of each light source, which is convenient for subsequent generation of the soft shadow effect.

In some embodiments of the present disclosure, the light source information includes a position of the light source, where the position of the light source is based on the relative offset information of the light source attached to the light source rigid body. The determining the directed distance of the target rendering pixel point for each light source according to the light source information and the blocking object information after the removal operation, includes: for each light source, moving the target rendering pixel point towards the position of the light source in a preset step size, and determining a directed distance of the target rendering pixel point after movement based on the blocking object information after the removal operation; if the directed distance reaches a preset distance threshold, continuously moving towards the position of the light source again by taking the directed distance as a step size, and determining a directed distance of the target rendering pixel point after movement again based on the blocking object information after the removal operation until the target rendering pixel point is moved to the position of the light source.

According to the above embodiments, the directed distance of the moving target rendering pixel point is determined based on the blocking object information after the removal operation, until the target rendering pixel point is moved to the position of the light source, so as to reduce the error.

In some embodiments of the present disclosure, the blocking object information after the removal operation includes dynamic blocking object information after the removal operation and static blocking object information before the removal operation. The determining the directed distance of the target rendering pixel point after movement based on the blocking object information after the removal operation, includes: obtaining a first minimum directed distance value from the dynamic blocking object information after the removal operation by traversing the target rendering pixel point after movement; obtaining a second minimum directed distance value by performing sampling on a static map corresponding to the target rendering pixel point after movement; and determining a smaller value in the first minimum directed distance value and the second minimum directed distance value as the directed distance of the target rendered pixel point after movement.

In some embodiments of the present disclosure, determining the illumination intensity ratio information of the light source to the target rendering pixel point based on the directed distance of the target rendering pixel point includes: obtaining a light source radius of the light source, and obtaining the illumination intensity ratio information of the target rendered pixel point by calculating a ratio of the directed distance of the target rendered pixel point to the light source radius.

According to the above embodiments, the determined illumination intensity ratio information may be used to indicate the influence degree of the light source on the shadow generation for the rendered pixel point, and the influence degree of the light source on the shadow generation for the rendered pixel point is known based on the illumination intensity ratio information determined according to the directed distance, and then the influence of the light source on the illumination percentage of the rendering pixel point needing illumination rendering in the virtual scene is known, which supports the generation of the soft shadow effect.

The embodiments in the description are all described in a progressive manner, each embodiment focuses on the differences from other embodiments, and the same or similar parts between the embodiments may refer to each other.

Those skilled in the art should understand that the embodiments of the embodiments of the present disclosure may be provided as a method, an apparatus, or a computer program product. Therefore, the embodiments of the present disclosure may take the form of an entirely hardware embodiment, an entirely software embodiment, or an embodiment combining the software aspect and the hardware aspect. In addition, the embodiments of the present disclosure may take the form of a computer program product implemented on one or more computer-usable storage medium (including but not limited to a disk memory, a CD-ROM, an optical memory, or the like) including computer-usable program codes.

The embodiments of the present disclosure are described with reference to the flowcharts and/or block diagrams of the method, the terminal device (system), and the computer program product according to the embodiments of the present disclosure. It should be understood that computer program instructions may be used to implement each process and/or block in the flowcharts and/or the block diagrams and a combination of the processes and/or the blocks in the flowcharts and/or the block diagrams. These computer program instructions may be provided to a processor of a general-purpose computer, a special-purpose computer, an embedded processor, or other programmable data processing terminal devices to produce a machine, so that the instructions executed by the processor of the computer or other programmable data processing terminal devices produce apparatuses for implementing the functions specified in one or more processes in the flowcharts and/or one or more blocks in the block diagrams.

These computer program instructions may also be stored in a computer-readable memory capable of guiding a computer or other programmable data processing terminal devices to work in a specific manner, so that the instructions stored in the computer-readable memory produce a manufactured product including an instruction apparatus. The instruction apparatus is used to implement the functions specified in one or more processes in the flowcharts and/or one or more blocks in the block diagrams.

These computer program instructions may also be loaded onto a computer or other programmable data processing terminal device, so that a series of operation steps are performed on the computer or other programmable terminal devices to generate computer-implemented processing, so that the instructions executed on the computer or other programmable terminal devices provide steps for implementing the functions specified in one or more flows of the flowcharts and/or one or more blocks in the block diagrams.

Although the preferred embodiments of the embodiments of the present disclosure have been described, those skilled in the art may make additional changes and modifications to these embodiments once they learn the basic inventive concept. Therefore, the appended claims are intended to be interpreted as including the preferred embodiments and all changes and modifications falling within the scope of the embodiments of the present disclosure.

Finally, it should also be noted that, in the description, relational terms such as “first” and “second” are only used to distinguish one entity or operation from another entity or operation, and do not necessarily require or imply that there is any such actual relationship or sequence between these entities or operations. Moreover, the terms “comprising”, “including” or any other variation of them are intended to cover a non-exclusive inclusion, so that a process, method, article, or terminal device that includes a series of elements includes not only those elements, but also other elements that are not explicitly listed, or elements inherent to such a process, method, article, or terminal device. In the absence of more restrictions, the statement “includes one. The element limited by the statement “including a . . . ” does not exclude the existence of additional identical elements in the process, method, item, or terminal device that includes the element.

The method for generating a soft shadow, the apparatus for generating a soft shadow, the corresponding electronic device and the corresponding computer storage medium provided by the present disclosure are described in detail above. The principles and embodiments of the present disclosure are described by using specific embodiment here, and the descriptions of the above embodiments are only used to help understand the method of the present disclosure and the core concept of the present disclosure. At the same time, for those of ordinary skill in the art, according to the concept of the present disclosure, there may be changes in specific embodiments and application ranges. In conclusion, the content of the present description should not be construed as limitations on the present disclosure.

1. A method for generating a soft shadow, comprising:
in response to a loading instruction for a game, obtaining blocking information of a virtual scene and light source information based on a light source in the virtual scene;
in a running process of the game, determining a target rendering pixel point in the virtual scene according to the light source information, wherein the target rendering pixel point is to be subjected to illumination rendering;
determining a directed distance of the target rendering pixel point according to the blocking information and the light source information; and
determining illumination intensity ratio of the light source to the target rendering pixel point based on the directed distance of the target rendering pixel point, wherein the illumination intensity ratio indicates an influence degree of the light source on shadow generation for the target rendering pixel point.

2. The method according to claim 1, wherein the blocking information comprises dynamic blocking information and static blocking information generated offline, and the method further comprises:
in response to determining the game is offline, obtaining a unit region of the virtual scene and a static blocking object in each unit region, generating a sampling grid for the static blocking object in each unit region, and storing the sampling grid in a corresponding static map; and
in response to determining the game is offline, binding the pre-configured light source information with a light source rigid body in the virtual scene.

3. The method according to claim 2, wherein obtaining the blocking information of the virtual scene and the light source information based on the light source in the virtual scene comprises:
reading the blocking information of the virtual scene by using the static map, retrieving corresponding light source information by using the light source rigid body in the virtual scene, and retrieving corresponding dynamic blocking information by using a dynamic blocking rigid body in the virtual scene.

4. The method according to claim 2, wherein the light source information comprises a light source radius and relative offset information of the light source attached to the light source rigid body, and determining the target rendering pixel point in the virtual scene according to the light source, comprises:
determining a position of the light source by using the relative offset information of the light source attached to the light source rigid body;
generating a bounding box for the light source based on the position of the light source, and determining a target screen frame according to the bounding box of the light source; and
determining, in the target screen frame, a rendering pixel point within a range of the light source radius as the target rendering pixel point.

5. The method according to claim 1, wherein the virtual scene comprises a light source, the light source information comprises a light source illumination direction, and determining the directed distance of the target rendering pixel point according to the blocking information and the light source information comprises:
performing a removal operation in sequence on a blocking object based on the blocking object information and a light source illumination direction of each light source to obtain blocking object information after the removal operation; and
determining the directed distance of the target rendering pixel point for each light source according to the light source information and the blocking object information after the removal operation.

6. The method according to claim 5, wherein performing the removal operation in sequence on the blocking object based on the blocking object information and the light source illumination direction of each light source to obtain the blocking object information after the removal operation, comprises:
generating a bounding box for each light source, and obtaining a dynamic blocking object intersecting with the bounding box of each light source, respectively; and
obtaining the blocking object information after the removal operation by removing a dynamic blocking object that is not in the light source illumination direction of each light source from the dynamic blocking object intersecting with the bounding box of each light source, wherein the blocking object information after the removal operation comprises dynamic blocking object information after the removal operation and static blocking object information before the removal operation.

7. The method according to claim 5, wherein the light source information comprises a position of the light source, the position of the light source is based on the relative offset information of the light source attached to the light source rigid body, and determining the directed distance of the target rendering pixel point for each light source according to the light source information and the blocking object information after the removal operation, comprises:
for each light source, moving the target rendering pixel point towards the position of the light source in a preset step size, and determining a directed distance of the target rendering pixel point after movement based on the blocking object information after the removal operation; and
in response to the directed distance reaching a preset distance threshold, continuously moving the target rendering pixel point towards the position of the light source again by taking the directed distance as a step size, and determining the directed distance of the target rendering pixel point after movement again based on the blocking object information after the removal operation until the target rendering pixel point is moved to the position of the light source.

8. The method according to claim 7, wherein the blocking object information after the removal operation comprises dynamic blocking object information after the removal operation and static blocking object information before the removal operation; and
determining the directed distance of the target rendering pixel point after movement based on the blocking object information after the removal operation, comprises:
obtaining a first minimum directed distance value from the dynamic blocking object information after the removal operation by traversing the target rendering pixel point after movement;
obtaining a second minimum directed distance value by performing sampling on a static map corresponding to the target rendering pixel point after movement; and
determining a smaller value in the first minimum directed distance value and the second minimum directed distance value as the directed distance of the target rendered pixel point after movement.

9. The method according to claim 1, wherein determining the illumination intensity ratio of the light source to the target rendering pixel point based on the directed distance of the target rendering pixel point, comprises:
obtaining a light source radius of the light source, and obtaining the illumination intensity ratio of the target rendered pixel point by calculating a ratio of the directed distance of the target rendered pixel point to the light source radius.

10. (canceled)

11. An electronic device, comprising a processor, a memory, and a computer program stored in the memory and capable of running on the processor, wherein when the computer program is executed by the processor, a method for generating a soft shadow is implemented, and the method comprises:
in response to a loading instruction for a game, obtaining blocking information of a virtual scene and light source information based on a light source in the virtual scene;
in a running process of the game, determining a target rendering pixel point in the virtual scene according to the light source information, wherein the target rendering pixel point is to be subjected to illumination rendering;
determining a directed distance of the target rendering pixel point according to the blocking information and the light source information; and
determining illumination intensity ratio of the light source to the target rendering pixel point based on the directed distance of the target rendering pixel point, wherein the illumination intensity ratio indicates an influence degree of the light source on shadow generation for the target rendering pixel point.

12. A non-transitory computer-readable storage medium, wherein a computer program is stored on the non-transitory computer-readable storage medium, and when the computer program is executed by a processor, a method for generating a soft shadow is implemented, and the method comprises:
in response to a loading instruction for a game, obtaining blocking information of a virtual scene and light source information based on a light source in the virtual scene;
in a running process of the game, determining a target rendering pixel point in the virtual scene according to the light source information, wherein the target rendering pixel point is to be subjected to illumination rendering;
determining a directed distance of the target rendering pixel point according to the blocking information and the light source information; and
determining illumination intensity ratio of the light source to the target rendering pixel point based on the directed distance of the target rendering pixel point, wherein the illumination intensity ratio indicates an influence degree of the light source on shadow generation for the target rendering pixel point.

13. The electronic device according to claim 11, wherein the blocking information comprises dynamic blocking information and static blocking information generated offline, and the method further comprises:
in response to determining the game is offline, obtaining a unit region of the virtual scene and a static blocking object in each unit region, generating a sampling grid for the static blocking object in each unit region, and storing the sampling grid in a corresponding static map; and
in response to determining the game is offline, binding the pre-configured light source information with a light source rigid body in the virtual scene.

14. The electronic device according to claim 13, wherein obtaining the blocking information of the virtual scene and the light source information based on the light source in the virtual scene, comprises:
reading the blocking information of the virtual scene by using the static map, retrieving corresponding light source information by using the light source rigid body in the virtual scene, and retrieving corresponding dynamic blocking information by using a dynamic blocking rigid body in the virtual scene.

15. The electronic device according to claim 13, wherein the light source information comprises a light source radius and relative offset information of the light source attached to the light source rigid body, and determining the target rendering pixel point in the virtual scene according to the light source, comprises:
determining a position of the light source by using the relative offset information of the light source attached to the light source rigid body;
generating a bounding box for the light source based on the position of the light source, and determining a target screen frame according to the bounding box of the light source; and
determining, in the target screen frame, a rendering pixel point within a range of the light source radius as the target rendering pixel point.

16. The electronic device according to claim 11, wherein determining the illumination intensity ratio of the light source to the target rendering pixel point based on the directed distance of the target rendering pixel point, comprises:
obtaining a light source radius of the light source, and obtaining the illumination intensity ratio of the target rendered pixel point by calculating a ratio of the directed distance of the target rendered pixel point to the light source radius.

17. The non-transitory computer-readable storage medium according to claim 12, wherein the virtual scene comprises a light source, the light source information comprises a light source illumination direction, and determining the directed distance of the target rendering pixel point according to the blocking information and the light source information comprises:
performing a removal operation in sequence on a blocking object based on the blocking object information and a light source illumination direction of each light source to obtain blocking object information after the removal operation; and
determining the directed distance of the target rendering pixel point for each light source according to the light source information and the blocking object information after the removal operation.

18. The non-transitory computer-readable storage medium according to claim 17, wherein performing the removal operation in sequence on the blocking object based on the blocking object information and the light source illumination direction of each light source to obtain the blocking object information after the removal operation, comprises:
generating a bounding box for each light source, and obtaining a dynamic blocking object intersecting with the bounding box of each light source, respectively; and
obtaining the blocking object information after the removal operation by removing a dynamic blocking object that is not in the light source illumination direction of each light source from the dynamic blocking object intersecting with the bounding box of each light source, wherein the blocking object information after the removal operation comprises dynamic blocking object information after the removal operation and static blocking object information before the removal operation.

19. The non-transitory computer-readable storage medium according to claim 17, wherein the light source information comprises a position of the light source, the position of the light source is based on the relative offset information of the light source attached to the light source rigid body, and determining the directed distance of the target rendering pixel point for each light source according to the light source information and the blocking object information after the removal operation, comprises:
for each light source, moving the target rendering pixel point towards the position of the light source in a preset step size, and determining a directed distance of the target rendering pixel point after movement based on the blocking object information after the removal operation; and
in response to the directed distance reaching a preset distance threshold, continuously moving the target rendering pixel point towards the position of the light source again by taking the directed distance as a step size, and determining the directed distance of the target rendering pixel point after movement again based on the blocking object information after the removal operation until the target rendering pixel point is moved to the position of the light source.

20. The non-transitory computer-readable storage medium according to claim 19, wherein the blocking object information after the removal operation comprises dynamic blocking object information after the removal operation and static blocking object information before the removal operation; and
determining the directed distance of the target rendering pixel point after movement based on the blocking object information after the removal operation, comprises:
obtaining a first minimum directed distance value from the dynamic blocking object information after the removal operation by traversing the target rendering pixel point after movement;
obtaining a second minimum directed distance value by performing sampling on a static map corresponding to the target rendering pixel point after movement; and
determining a smaller value in the first minimum directed distance value and the second minimum directed distance value as the directed distance of the target rendered pixel point after movement.

21. The non-transitory computer-readable storage medium according to claim 12, wherein determining the illumination intensity ratio of the light source to the target rendering pixel point based on the directed distance of the target rendering pixel point, comprises:
obtaining a light source radius of the light source, and obtaining the illumination intensity ratio of the target rendered pixel point by calculating a ratio of the directed distance of the target rendered pixel point to the light source radius.
